(19) United States
(12) Patent Application Publication
(10) Pub. No.: US 2021/0272226 A1
(43) Pub. Date: Sep. 2, 2021

(54) SYSTEM FOR MONITORING AND ANALYZING SHIPPING

(71) Applicant: CARRIER CORPORATION, Palm Beach Gardens, FL (US)

(72) Inventor: Mihir SHAH, Palm Beach Gardens, FL (US)

(21) Appl. No.: 17/252,403

(22) PCT Filed: Nov. 26, 2019
(86) PCT No.: PCT/US2019/063205

§ 371 Date: Dec. 15, 2020

Related U.S. Application Data
(60) Provisional application No. 62/782,586, filed on Dec. 20, 2018.

(51) Int. Cl. G06Q 50/28; G01K 3/04; G01J 1/42

(52) U.S. Cl. CPC G06Q 50/28; G06Q 10/0637; G01J 1/4204; G01K 3/04

(57) ABSTRACT

A method of analyzing conditions pertaining to a shipping container includes determining container characteristics during a trip, which include at least one of a temperature within the container over time, a set point temperature, a number of times the container is opened, a change in contents within the container, or an amount of light within the container over time. Determined trip characteristics include at least one of a number of stops along the trip, an amount of time that passes during the trip, a number of day-night cycles during the trip, or a distance traveled by the container. Container relationships between the determined container characteristics and corresponding characteristics from selected previous trips are determined along with trip relationships between the determined trip characteristics and corresponding characteristics from the previous trips. An output includes information regarding the container relationships, trip relationships, container characteristics and trip characteristics.

### CROSS REFERENCE TO RELATED APPLICATIONS

This application claims priority to U.S. Provisional Application No. 62/782,586, which was filed on Dec. 20, 2018, and is incorporated herein by reference.

### BACKGROUND

Various factors affect performance and results during transit including the tendencies of a carrier or shipping company and the conditions along a shipment route. Some aspects of shipper performance may have an adverse effect on the shipped items in some cases. The reasons why some shipments are successful or satisfactory and others are not can be varied and complex. While various proposals have been made and various products or services are available to monitor the conditions within shipping containers most of them merely provide information as a basic or straightforward report of the measured conditions, such as temperature, over time.

### SUMMARY

An illustrative example embodiment of a method of analyzing conditions pertaining to a shipping container during a trip includes determining a plurality of container characteristics of the shipping container during the trip. The container characteristics include at least one of a temperature within the shipping container at each a plurality of times, a set point temperature for an interior of the shipping container, a number of times the shipping container is opened, a change in contents within the shipping container, or an amount of light within the shipping container at each of a plurality of times. The method includes determining a plurality of trip characteristics, which include at least one of a number of stops along the trip, an amount of time that passes between the shipping container leaving an initial location and arriving at a selected destination, a number of day-night cycles during the trip, or a distance traveled by the shipping container between the initial location and the selected destination. A plurality of container relationships between the determined container characteristics during the trip and corresponding container characteristics from selected previous trips are determined along with a plurality of trip relationships between the determined trip characteristics of the trip and corresponding trip characteristics from the selected previous trips. An output includes information regarding the determined container relationships, the determined trip relationships, the determined container characteristics and the determined trip characteristics.

An example embodiment having one or more features of the method of the previous paragraph includes determining at least one value associated with the temperature. The value comprises at least one of a maximum temperature, a minimum temperature, an average temperature during the trip, or a standard deviation based on the determined temperature at the plurality times during the trip. Determining the plurality of container relationships includes determining a difference between the determined value and corresponding values from the selected previous trips.

In an example embodiment having one or more features of the method of any of the previous paragraphs, determining the number of day-night cycles comprises determining an average temperature within the container for each of a plurality of portions of the trip, determining a pattern of change in the determined average temperature, and determining whether the pattern of change corresponds to at least one change between day and night conditions.

In an example embodiment having one or more features of the method of any of the previous paragraphs, determining at least one of the container characteristics comprises determining the at least one of the container characteristics at each of a plurality of measurement instances, wherein the measurement instances are spaced apart by an interval having a first duration; determining an average of the determined at least one of the container characteristics for each of a plurality of periods, wherein the periods each have a second duration that is greater than the first duration, and wherein the periods each include respective ones of the measurement instances; and using the determined average for the periods as the determined at least one of the container characteristics at the plurality of times.

In an example embodiment having one or more features of the method of any of the previous paragraphs, the at least one of the container characteristics comprises the temperature within the shipping container.

In an example embodiment having one or more features of the method of any of the previous paragraphs, the at least one of the container characteristics comprises the amount or brightness of the light within the container.

In an example embodiment having one or more features of the method of any of the previous paragraphs, the selected previous trips are between the initial location and the selected destination, and contents within the shipping container are similar during the trip and the previous trips.

In an example embodiment having one or more features of the method of any of the previous paragraphs, the output includes information regarding conditions of the shipping container at a detector-specific level, a shipment-specific level and a shipping program level.

In an example embodiment having one or more features of the method of any of the previous paragraphs, the output includes indications of whether at least one of the temperature or light within the shipping container was continuous during the trip, how a standard deviation, a minimum, a maximum, or an average of the at least one of temperature or light within the shipping container during the trip compares to corresponding temperature or light characteristics on the previous trips, whether the at least one of the temperature or light within the shipping container remained within a predetermined range, whether the set point temperature deviated from a desired set point temperature, how the number of stops on the trip compares to numbers of stops on the previous trips, how the trip duration compares to trip durations of the previous trips, how the distance traveled compares to distances traveled on the previous trips, whether the amount or brightness of the light in the container varied during the trip, and the number of day-night cycles during the trip.

An illustrative example embodiment of a system for analyzing conditions pertaining to a shipping container during a trip from an initial location to a selected destination includes a first plurality of detectors that detect respective container characteristics of the shipping container during the trip. The container characteristics including at least one of a temperature within the shipping container at each a plurality of times, a set point temperature for an interior of the shipping container, how much the shipping container is opened, a change in contents within the shipping container, or an amount of light within the shipping container at each of a plurality of times. A second plurality of detectors detect respective trip characteristics including at least one of a number of stops along the trip, an amount of time that passes between the shipping container leaving the initial location and arriving at the selected destination, a number of day-night cycles during the trip, or a distance traveled by the shipping container between the initial location and the selected destination. A processor determines a plurality of container relationships between the detected container characteristics during the trip and corresponding container characteristics from selected previous trips, and a plurality of trip relationships between the detected trip characteristics of the trip and corresponding trip characteristics from the selected previous trips. A user interface provides an output that includes information regarding the determined container relationships, the determined trip relationships, the detected container characteristics and the detected trip characteristics.

In an example embodiment having one or more features of the system of the previous paragraph, the processor determines the plurality of container relationships by determining an average value for each of the container characteristics from the selected previous trips and determining a difference between any of the determined container characteristics of the shipping container during the trip and the determined average value for the corresponding container characteristic from the selected previous trips.

In an example embodiment having one or more features of the system of any of the previous paragraphs, the processor determines at least one value associated with the temperature, the value comprises at least one of a maximum temperature, a minimum temperature, an average temperature during the trip, or a standard deviation based on the determined temperature at the plurality times during the trip, and the processor determines the plurality of container relationships by determining a difference between the determined value and corresponding values from the selected previous trips.

In an example embodiment having one or more features of the system of any of the previous paragraphs, the processor determines the number of day-night cycles by determining an average temperature within the container for each of a plurality of portions of the trip, determining a pattern of change in the determined average temperature, and determining whether the pattern of change corresponds to at least one change between day and night conditions.

In an example embodiment having one or more features of the system of any of the previous paragraphs, the processor determines at least one of the container characteristics by determining the at least one of the container characteristics at each of a plurality of measurement instances, wherein the measurement instances are spaced apart by an interval having a first duration, determining an average of the determined at least one of the container characteristics for each of a plurality of periods, wherein the periods each have a second duration that is greater than the first duration, and wherein the periods each include respective ones of the measurement instances, and using the determined average for the periods as the determined at least one of the container characteristics at the plurality of times.

In an example embodiment having one or more features of the system of any of the previous paragraphs, the at least one of the container characteristics comprises the temperature within the shipping container.

In an example embodiment having one or more features of the system of any of the previous paragraphs, the at least one of the container characteristics comprises the amount or brightness of the light within the container.

In an example embodiment having one or more features of the system of any of the previous paragraphs, the selected previous trips are between the initial location and the selected destination and contents within the shipping container are similar during the trip and the previous trips.

In an example embodiment having one or more features of the system of any of the previous paragraphs, the output includes information regarding conditions of the shipping container at a detector-specific level, a shipment-specific level and a shipping program level.

In an example embodiment having one or more features of the system of any of the previous paragraphs, the output includes indications of whether at least one of the temperature or light within the shipping container was continuous during the trip, how a standard deviation, a maximum, a minimum, or an average of the at least one of the temperature or light within the shipping container during the trip compares to corresponding temperature or light characteristics on the previous trips, whether the temperature or light within the shipping container remained within a predetermined range, whether the set point temperature deviated from a desired set point temperature, how the number of stops on the trip compares to numbers of stops on the previous trips, how the trip duration compares to trip durations of the previous trips, how the distance traveled compares to distances traveled on the previous trips, whether the amount or brightness of the light in the container varied during the trip, and the number of day-night cycles during the trip.

The various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a system designed according to an embodiment of this invention.

FIG. 2 schematically illustrates selected features of a processor designed according to an embodiment of this invention.

FIG. 3 is a flow chart diagram summarizing an example monitoring technique designed according to an embodiment of this invention.

FIG. 4 is a flow chart diagram summarizing a feature of the example technique shown in FIG. 3.

### DETAILED DESCRIPTION

Embodiments of this invention provide information regarding characteristics of a shipment, characteristics of a trip taken during the shipment, and relationships between such characteristics and those of other similar trips. The information is useful to a variety of entities that may be involved in a shipment, such as suppliers or sellers of goods, shippers that are responsible for transportation, or receivers or buyers of goods. Embodiments of this invention provide the ability to obtain and analyze information at a detector-specific or characteristic level, a system-specific or trip level, and a shipping program level. Such information provides the ability to monitor and adjust a variety of aspects or strategies for how temperature-controlled shipping containers are used in a variety of scenarios.

FIG. 1 schematically illustrates a system 20 for monitoring and analyzing conditions pertaining to a shipping container 22 during a trip that includes the shipping container 22 traveling from an initial location to a selected destination. The shipping container 22 may be a temperature-controlled container, such as an intermodal container or a truck trailer, for example. A refrigerant circuit 24 includes known components for maintaining a desired temperature within the container 22 to provide the necessary conditions for contents or cargo within the container 22.

A plurality of detectors provide information regarding a respective plurality of container characteristics during a trip. A temperature detector 30 provides information regarding a temperature within the container 22. Multiple temperature detectors are included for specifically monitoring particular portions within the container 22 in some embodiments. In the illustrated example, the temperature detector 30 provides information regarding the temperature inside the container 22 at each of a plurality of times during a trip.

The illustrated example includes a contents monitor 32 that provides information or an indication of the type or amount of contents within the container 22. Various known devices can be used as a contents monitor, such as a barcode reader if the contents include a barcode that can be scanned as the contents are loaded onto or removed from the container 22. Another example contents monitor includes an RFID tag reader that uses known techniques for communicating with RFID tags associated with contents placed within the container 22. Some embodiments include load detectors that measure a weight of the contents within the container 22. Camera-based detection may also be used to monitor the contents. A dedicated contents monitor is not required in some embodiments but, instead, information regarding the contents is identified based on characteristics of the temperature and light in the container 22.

A light detector 34 provides information regarding an amount or brightness of light within the container 22. One use for the light detector 34 is to monitor whether doors 35 of the container 22 are open. In general, if one of the doors 35 is open, there will be more light inside the container 22 compared to when both doors 35 are fully closed. The illustrated example includes a dedicated door detector 36 that provides an indication of whether the doors 35 are both closed or either one is open. Many embodiments do not include a door detector 36. In such embodiments, the light and temperature in the container 22 are used to identify whether the doors 35 are open during a shipment. Information regarding whether the doors 35 are open or closed and how long a door is open is useful for analyzing performance of the refrigerant circuit 24 for maintaining a desired set point temperature within the container 22, for example.

The illustrated example includes a position or location detector 38 such as a GPS receiver for identifying a location of the container 22 and tracking movement of the container 22 during a trip. The position detector 38 may be situated on another portion of a vehicle associated with the container 22 or supported directly on the container 22.

A processor 40 receives information from the plurality of detectors regarding the respective characteristics pertaining to the container 22 to provide information to a user of the shipping container, such as a shipping company, a manufacturer or another entity. As schematically shown in FIG. 1, the processor 40 includes a portion supported on the shipping container 22 or an associated vehicle. That portion of the processor is configured to receive indications from the sensors on board the vehicle. Another portion of the processor 40 comprises a computing device that is configured to receive information from the portion supported on the vehicle and process all information regarding the shipping containers during multiple trips. For discussion purposes, the computing device portion of the example processor is shown as part of a shipper server and database 42. Given this description, those skilled in the art will realize what configuration of computing devices will best meet their particular needs for a processor 40.

The system 20 includes a user interface 44 that provides an output of information pertaining to the shipping container 22 for a particular trip based on determinations by the processor 40 and information in the database 42. In the illustrated example, the output available through the user interface 44 includes information on a detector-specific or characteristic level, a system performance or trip-specific level, and a shipping program level including relationships between information regarding a particular shipping container or trip and other containers or trips.

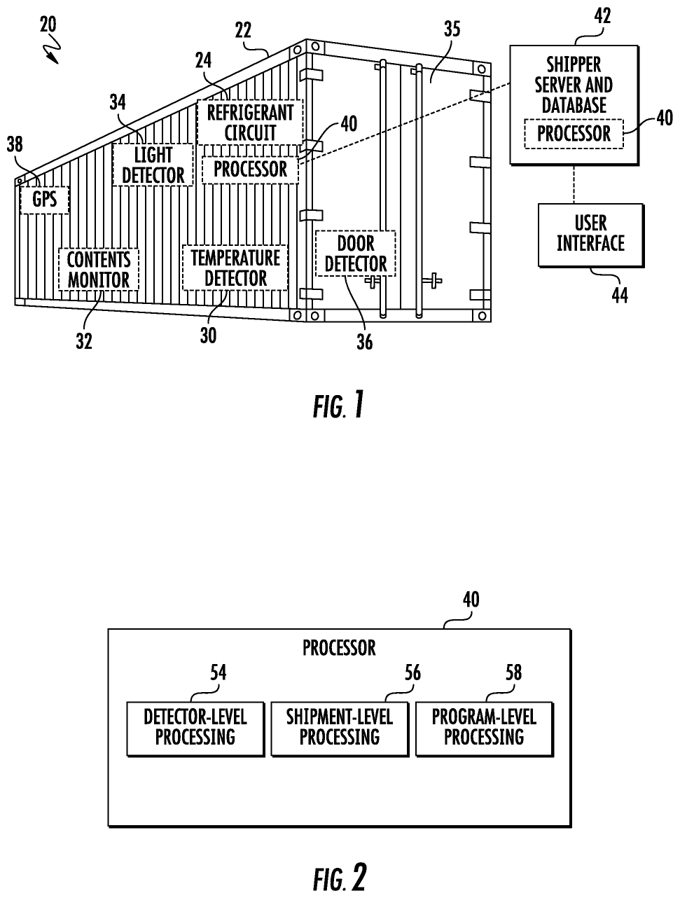

FIG. 2 schematically illustrates an example configuration of the computing portion of the processor 40 including a detector-level processing module 54 that is responsible for interpreting information from the plurality of detectors regarding the container characteristics, analyzing such information and providing the corresponding portions of the output, which can be available through the user interface 44. A shipment-level processing module 56 is configured to receive indications regarding trip characteristics, process such information, and provide a corresponding output. A program-level processing module 58 is configured to use information from the database 42 and information regarding the shipping container 22 and a particular trip for providing an output that relates such information to corresponding information from other trips. These three levels of information provide a container owner or shipping company insight and information that previously has not been provided in the manner that the illustrated example embodiment does.

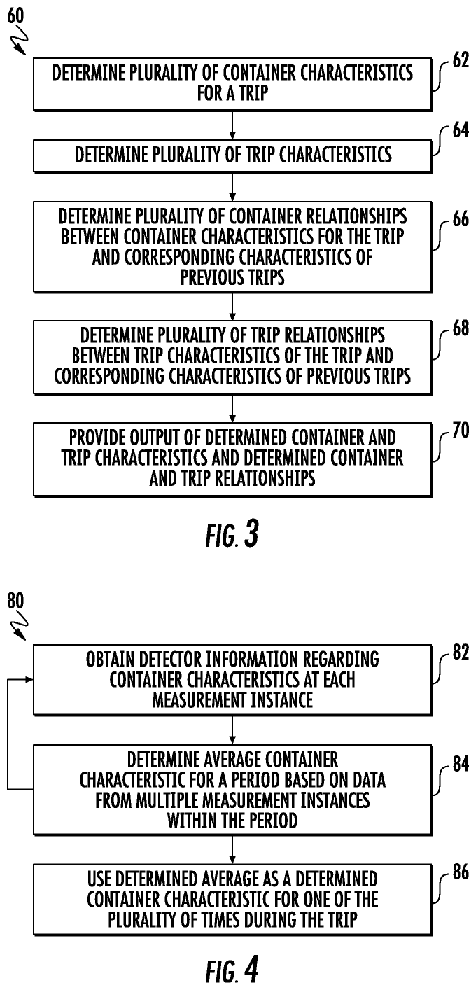

FIG. 3 is a flowchart diagram 60 summarizing an example method of monitoring and analyzing conditions pertaining to the shipping container 22 during a trip. At 62, one or more of the plurality of detectors 30-38 detect respective container characteristics during a trip. The processor 40 uses the gathered information to determine the container characteristics.

In one example, determining the plurality of container characteristics at 62 includes determining at least one of a temperature within the shipping container 22 at each of a plurality of times, a set point temperature for an interior of the container 22, a number of times the container 22 was open, a change in the contents within the container 22, or an amount or brightness of light within the container 22 at each of a plurality of times.

At 64, one or more of the detectors 30-38 provides an indication of respective trip characteristics. The processor 40 determines the plurality of trip characteristics at 64 based on the detector indications.

Determining the plurality of trip characteristics at 64 includes determining at least one of a number of stops along the trip, a trip duration between the shipping container 22 leaving an initial location and arriving at a selected destination, a number of day-night cycles during the trip, or a distance traveled by the shipping container 22 between the initial location and the selected destination. The particular characteristics used for a given trip may vary and those skilled in the art who have the benefit of this description will be able to select appropriate characteristics that provide useful information for their particular situation.

At 66, the processor 40 determines a plurality of container relationships between the container characteristics for the trip and corresponding characteristics of previous trips. Determining a plurality of container relationships at 66 includes determining respective comparison values based on the container characteristics from the selected previous trips. One or more of the container relationships is based on a difference between any of the determined container characteristics of the container 22 during the trip and the respective comparison value for the corresponding container characteristic from the previous trips. Example comparison values include an average of a container characteristic over a plurality of previous trips or a standard deviation of values for a particular characteristic. Some examples include determining the container relationships by determining a difference between a standard deviation of temperature values during a trip and temperature standard deviations from previous trips.

At 68, the processor 40 determines a plurality of trip relationships between the trip characteristics of the current trip and corresponding characteristics of previous trips. At 70, the processor 40 controls the user interface 44 to provide the output of the determined container and trip characteristics and the determined container and trip relationships. This approach includes multi-layer analysis and reporting of information that is as particular as specific sensor or detector indications and as general or broad as information regarding an entire shipping program, such as the relationships between any of the characteristics of a particular trip and other trips completed by an entity, such as a shipping company.

The detector-level information provides specifics in a customizable manner so that the output includes as much information as desired regarding specific container characteristics. For example, it may be useful to know the temperature within the container 22 on a specifically chosen periodic basis. The detector-level information is also useful for identifying when a particular detector is malfunctioning or otherwise not providing reliable information.

In some example embodiments, a time scale approach is used for determining or identifying values for a container characteristic. FIG. 4 includes a flowchart diagram 80 that summarizes an example approach. At 82, at least one of the detectors associated with the container 22 provides information regarding the corresponding container characteristic at a plurality of measurement instances, such as every minute. At 84, the processor 40 determines an average container characteristic value for a period of time based on data from multiple measurement instances within the period. For example, when temperature is measured every minute, the average temperature for an hour is determined based upon each of the temperature measurements for the 60 minutes of that hour. At 86, the determined average is used as the determined container characteristic for one of the plurality of times of interest.

For example, when a trip lasts 48 hours, there are 48 times when the temperature is considered. Instead of taking one measurement every hour, this example embodiment includes taking a measurement every minute and then averaging the measured temperatures for each hour and using each hour's average temperature as the determined container temperature characteristic. In other example implementations the measurement instances are spaced apart by an interval having a first duration that is different than a minute and the periods have a second duration that is different than an hour. The second duration is greater or longer than the first duration. This time scale approach may be used for several of the container or trip characteristics depending on the needs of a particular situation.

Some trips will last several days between the initial location where contents are loaded into the container 22 and the final destination for those contents. In such situations, the system 20 has the capability of determining a number of day-night cycles during the trip. That determination is based on temperature information from the temperature detector 30 or information regarding operation of the refrigerant circuit 24. Since daytime ambient temperatures are typically higher than nighttime ambient temperatures, changes in the temperature detected by the temperature detector 30 or the operation of the refrigerant circuit 24 may follow a pattern that corresponds to changes between night and day. For example, the processor 40 determines an average temperature within the container 22 for each of a plurality of portions of the trip. The processor 40 determines a pattern of change in the determined average temperatures and determines whether that pattern corresponds to at least one change between day and night conditions. Recognizing multiple changes allows the processor 40 to provide information regarding how many day-night cycles occurred during the trip. External or ambient heat load can impact the cooling requirements within the container 22 and the day-night cycle information provides further insight into the performance of the refrigeration circuit 24 and the condition of the container 22, for example, during a trip. Additionally, such day-night cycle information is useful when comparing various characteristics of multiple trips.

As mentioned above, the output provided through the user interface 44 includes information regarding conditions of the shipping container at a detector-specific level, a shipment-specific level, and a shipping program level. For example, the output includes an indication of whether the temperature within the shipping container 22 was continuous during the trip. Assuming the temperature was not continuous, the output indicates how a standard deviation of temperatures within the container 22 during the trip compares to standard deviations of the temperature on previous trips. The output can include an indication of whether the temperature within the shipping container 22 exceeded a minimum or a maximum desired temperature or otherwise remained within a predetermined range of temperatures. The output in the illustrated example embodiment also includes whether the set point temperature for the refrigerant circuit 24 or the cooling apparatus of the container 22 deviated from a desired set point temperature. This may indicate, for example, user error or a potential problem with a control feature of the refrigerant circuit 24 or its associated components. For example, if the temperature pattern is continuous and the standard deviation is higher than ideal, that indicates that the set point was not set correctly for the given product that is being transported.

Additional information within the output includes an indication of how a number of stops along the trip compares to the number of stops on previous trips. The number of stops experienced by the container 22 provides information regarding the trip that is useful for analyzing or understanding some performance characteristics of the container 22. The output also includes an indication of how the trip duration and the distance traveled compares to the duration and distance of previous trips. The output also includes an indication of whether the amount or brightness of light in the container 22 varied during the trip, which can indicate how often the doors 35 were opened. The output also includes an indication of the number of day-night cycles during the trip.

The system 20 and the associated method of using it provides an improvement to monitoring and analyzing the performance or conditions of a shipping container, and associated cooling apparatus for that container, or both. Embodiments of this invention also provide an improvement to techniques for analyzing and understanding how various factors associated with a trip in relation to other trips can be adjusted to realize better or more consistent performance of a shipping container and its associated components.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A method of analyzing conditions pertaining to a shipping container during a trip from an initial location to a selected destination, the method comprising:
determining a plurality of container characteristics of the shipping container during the trip including at least one of
a temperature within the shipping container at each a plurality of times,
a set point temperature for an interior of the shipping container,
how much the shipping container is opened,
a change in contents within the shipping container, or
an amount or brightness of light within the shipping container at each of a plurality of times;
determining a plurality of trip characteristics of the trip including at least one of
a number of stops along the trip,
a trip duration between the shipping container leaving the initial location and arriving at the selected destination,
a number of day-night cycles during the trip, or
a distance traveled by the shipping container between the initial location and the selected destination;
determining a plurality of container relationships between the determined container characteristics during the trip and corresponding container characteristics from selected previous trips;
determining a plurality of trip relationships between the determined trip characteristics of the trip and corresponding trip characteristics from the selected previous trips; and
providing an output that includes information regarding the determined container relationships, the determined trip relationships, the determined container characteristics and the determined trip characteristics.

2. The method of claim 1, wherein determining the plurality of container relationships comprises
determining respective comparison values based on the container characteristics from the selected previous trips; and
determining a difference between any of the determined container characteristics of the shipping container during the trip and the respective comparison value for the corresponding container characteristic from the selected previous trips.

3. The method of claim 1, comprising determining at least one value associated with the temperature; and
wherein
the value comprises at least one of a maximum temperature, a minimum temperature, an average temperature during the trip, or a standard deviation based on the determined temperature at the plurality times during the trip; and
determining the plurality of container relationships includes determining a difference between the determined value and corresponding values from the selected previous trips.

4. The method of claim 1, wherein determining the number of day-night cycles comprises
determining an average temperature within the container for each of a plurality of portions of the trip;
determining a pattern of change in the determined average temperature; and
determining whether the pattern of change corresponds to at least one change between day and night conditions.

5. The method of claim 1, wherein determining at least one of the container characteristics comprises
determining the at least one of the container characteristics at each of a plurality of measurement instances, wherein the measurement instances are spaced apart by an interval having a first duration;
determining an average of the determined at least one of the container characteristics for each of a plurality of periods, wherein the periods each have a second duration that is greater than the first duration, and wherein the periods each include respective ones of the measurement instances; and
using the determined average for the periods as the determined at least one of the container characteristics at the plurality of times.

6. The method of claim 5, wherein the at least one of the container characteristics comprises the temperature within the shipping container.

7. The method of claim 5, wherein the at least one of the container characteristics comprises the amount or brightness of the light within the container.

8. The method of claim 1, wherein
the selected previous trips are between the initial location and the selected destination; and
contents within the shipping container are similar during the trip and the previous trips.

9. The method of claim 1, wherein the output includes information regarding conditions of the shipping container at a detector-specific level, a shipment-specific level and a shipping program level.

10. The method of claim 1, wherein the output includes indications of
whether at least one of the temperature or light within the shipping container was continuous during the trip,
how a standard deviation, a minimum, a maximum, or an average of the at least one of temperature or light within the shipping container during the trip compares to corresponding temperature or light characteristics on the previous trips,
whether the at least one of the temperature or light within the shipping container remained within a predetermined range,
whether the set point temperature deviated from a desired set point temperature,
how the number of stops on the trip compares to numbers of stops on the previous trips,
how the trip duration compares to trip durations of the previous trips,
how the distance traveled compares to distances traveled on the previous trips,
whether the amount or brightness of the light in the container varied during the trip, and
the number of day-night cycles during the trip.

11. A system for analyzing conditions pertaining to a shipping container during a trip from an initial location to a selected destination, the system comprising:
a first plurality of detectors that detect respective container characteristics of the shipping container during the trip, the container characteristics including at least one of
a temperature within the shipping container at each a plurality of times,
a set point temperature for an interior of the shipping container,
how much the shipping container is opened,
a change in contents within the shipping container, or
an amount of light within the shipping container at each of a plurality of times;
a second plurality of detectors that detect respective trip characteristics of the trip, the trip characteristics including at least one of
a number of stops along the trip,
an amount of time that passes between the shipping container leaving the initial location and arriving at the selected destination,
a number of day-night cycles during the trip, or
a distance traveled by the shipping container between the initial location and the selected destination;
a processor that determines
a plurality of container relationships between the detected container characteristics during the trip and corresponding container characteristics from selected previous trips, and
a plurality of trip relationships between the detected trip characteristics of the trip and corresponding trip characteristics from the selected previous trips; and
a user interface that provides an output that includes information regarding the determined container relationships, the determined trip relationships, the detected container characteristics and the detected trip characteristics.

12. The system of claim 11, wherein the processor determines the plurality of container relationships by
determining an average value for each of the container characteristics from the selected previous trips; and
determining a difference between any of the determined container characteristics of the shipping container during the trip and the determined average value for the corresponding container characteristic from the selected previous trips.

13. The system of claim 11, wherein the processor determines at least one value associated with the temperature; and
wherein
the value comprises at least one of a maximum temperature, a minimum temperature, an average temperature during the trip, or a standard deviation based on the determined temperature at the plurality times during the trip; and
the processor determines the plurality of container relationships by determining a difference between the determined value and corresponding values from the selected previous trips.

14. The system of claim 11, wherein the processor determines the number of day-night cycles by
determining an average temperature within the container for each of a plurality of portions of the trip;
determining a pattern of change in the determined average temperature; and
determining whether the pattern of change corresponds to at least one change between day and night conditions.

15. The system of claim 11, wherein the processor determines at least one of the container characteristics by
determining the at least one of the container characteristics at each of a plurality of measurement instances, wherein the measurement instances are spaced apart by an interval having a first duration;
determining an average of the determined at least one of the container characteristics for each of a plurality of periods, wherein the periods each have a second duration that is greater than the first duration, and wherein the periods each include respective ones of the measurement instances; and
using the determined average for the periods as the determined at least one of the container characteristics at the plurality of times.

16. The system of claim 15, wherein the at least one of the container characteristics comprises the temperature within the shipping container.

17. The system of claim 15, wherein the at least one of the container characteristics comprises the amount or brightness of the light within the container.

18. The system of claim 11, wherein
the previous trips are between the initial location and the selected destination; and
contents within the shipping container are similar during the trip and the previous trips.

19. The system of claim 11, wherein the output includes information regarding conditions of the shipping container at a detector-specific level, a shipment-specific level and a shipping program level.

20. The system of claim 11, wherein the output includes indications of
whether at least one of the temperature or light within the shipping container was continuous during the trip,
how a standard deviation, a maximum, a minimum, or an average of the at least one of the temperature or light within the shipping container during the trip compares to corresponding temperature or light characteristics on the previous trips,
whether the temperature or light within the shipping container remained within a predetermined range,
whether the set point temperature deviated from a desired set point temperature,
how the number of stops on the trip compares to numbers of stops on the previous trips,
how the trip duration compares to trip durations of the previous trips,
how the distance traveled compares to distances traveled on the previous trips,
whether the amount or brightness of the light in the container varied during the trip, and
the number of day-night cycles during the trip.
